(19) United States
(12) Patent Application Publication
(10) Pub. No.: US 2024/0362527 A1
(43) Pub. Date: Oct. 31, 2024

(54) MACHINE LEARNING USING RATE ADJUSTMENT FUNCTIONS OF UNMIXEDSECOND-ORDER DERIVATIVE ESTIMATES

(71) Applicants: ANTHONY JUSTIN NGUYEN, MILPITAS, CA (US); HAO-NHIEN QUI VU, FOUNTAIN VALLEY, CA (US); CYNTHIA KATHERINE NGUYEN, MILPITAS, CA (US); DARRION VINH NGUYEN, MILPITAS, CA (US)

(72) Inventors: ANTHONY JUSTIN NGUYEN, MILPITAS, CA (US); HAO-NHIEN QUI VU, FOUNTAIN VALLEY, CA (US); CYNTHIA KATHERINE NGUYEN, MILPITAS, CA (US); DARRION VINH NGUYEN, MILPITAS, CA (US)

(21) Appl. No.: 18/306,248

(22) Filed: Apr. 25, 2023

(51) Int. Cl. G06N 20/00

(52) U.S. Cl. CPC G06N 20/00

(57) ABSTRACT

The present disclosure generally relates to the field of Machine Learning, more particularly, methods and apparatuses to tune learning rates to accelerate training and avoid non-convergence. The new method utilizes estimates of the first-order derivatives and the unmixed second-order derivatives of the cost function relative to model parameters and a rate adjustment function to update the model parameters iteratively during model training.

### TECHNICAL FIELD

The present disclosure generally relates to tuning and accelerating large-scale Machine Learning models such as Artificial Neural Networks.

### BACKGROUND

Machine Learning involves using optimization to train models to derive useful information from raw data with minimal errors. Gradient Descent and its variations such as Stochastic Gradient Descent are optimization algorithms that use first-order derivatives of a cost function to find an optimal solution. Second-order optimization algorithms, such as the Newton's method, utilize the Hessian matrix of second-order partial derivatives to find an optimal solution. In Machine Learning models such as Artificial Neural Networks where there are large numbers of parameters to be learned, second-order optimization becomes computationally expensive because the size of the Hessian matrix is the square of the number of parameters. First-order optimization algorithms such as Gradient Descent are less expensive, but they require difficult hyperparameter tunings, in particular tuning the learning rates. A small learning rate will result in long training time, while too high learning rate may result in instability and nonconvergence.

This disclosure describes a new optimization method for Machine Learning that uses estimates of first-order derivatives and non-mixed second-order derivatives, requires less computation than conventional second-order methods, and can tune it learning rates automatically and effectively.

### BRIEF DESCRIPTION OF THE DRAWINGS

To provide a more complete understanding of the present disclosure and advantages thereof, reference is made to the attached drawings in which:

FIG. 1 illustrates the search paths of a conventional Machine Learning method using Gradient Descent with different learning rates.

FIG. 2 illustrates a flow chart of an embodiment of the new Machine Learning method using a rate adjustment function of unmixed second-order derivative estimates.

FIG. 3 illustrates two embodiments of the rate adjustment function.

FIG. 4 illustrates the search paths of the new method using a rate adjustment function with different input learning rates.

FIG. 5 compares the search paths of the new method versus the conventional Gradient Descent method in a model with a quadratic cost function.

FIG. 6 compares the search paths of the new method versus the convention Gradient Descent method in a model with a cubic cost function.

FIG. 7 illustrates a flow chart of an embodiment of the new Machine Learning method using average derivative estimates.

### DESCRIPTION OF EXAMPLE EMBODIMENTS

A typical Machine Learning process involves building a computational model that takes raw input data points and computes output data points that represent useful semantics. The model has a set of parameters that need to be learned during training. The goal of the training is to find the values for the model parameters such that for a set of input data points, the model calculates output data points that best fit a set of desirable target output data points. The set of input data points and target output data points is called the training data set. A cost function C is used to measure quantitatively how model output data points deviate from target output data points. The goal of the training is to find the values for the model parameters that minimize the cost function C over the training data set.

For example, a typical Machine Learning process using Stochastic Gradient Descent involves the following steps:
1. Initialize each model parameter pᵢ to some value Pᵢ.
2. Sample a batch of one or multiple input data points from the training data set, feed the input data points to the model to calculate output data points and their cost function C.
3. For each parameter pᵢ, make a small variation h to its value and recalculate the cost function C to get an estimate of the first-order derivative of C relative to pᵢ:

$${C}_{i}^{′} = ( C ( {P}_{i} + h ) - C ( {P}_{i} ) ) / h$$

4. Use the estimate of the first-order derivative of C relative to pᵢ to update the value of Pᵢ:

$${P}_{i} = {P}_{i} - R \cdot {C}_{i}^{′}$$

Where R is a learning rate.
5. Repeat steps 2 to 4 until training is done, e.g. the model parameters converge.

An issue with the above method is that it is often difficult to find a good learning rate R that achieves fast convergence for a wide range of problems. A small learning rate will result in long training time, while a too high learning rate may result in nonconvergence.

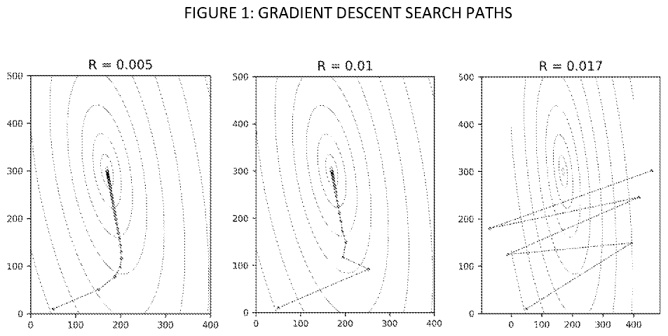

FIG. 1 shows the search paths of a Machine Learning model with two parameters using Gradient Descent with various learning rates. With a small learning rate of 0.005, the search path converges smoothly but slowly to the optimal solution. At a higher rate of 0.01, the search path has some overshoots but still converges. At a rate of 0.017, the model becomes unstable and does not converge.

To avoid nonconvergence, Machine Learning models often require some tuning of the learning rates, either by trial and error or automatically. For example, Backtracking Line Search adjusts the learning rate by starting with a large learning rate and iteratively reducing the learning rate until an adequate improvement in the cost function is observed. However, such an approach is often complex and expensive computationally.

Another approach is to use moments of the gradient vectors of the cost function to adjust the learning rates. This approach is used in popular Machine Learning methods such as AdaGrad, RMSProp, and Adam. For example, an embodiment of Adam (Adaptive Moment Estimation) may have the following steps:
1. Initialize each model parameter pᵢ to some value Pᵢ and initialize first and second moment estimates uᵢ and vᵢ to 0.
2. Sample a batch of one or multiple input data points from the training data set, feed the input data points to the model to calculate output data points and their cost function C.
3. For each parameter pᵢ, make a small variation h to its value and recalculate the cost function C to get an estimate of the first-order derivative of C relative to pᵢ:

$${C}_{i}^{′} = ( C ( {P}_{i} + h ) - C ( {P}_{i} ) ) / h$$

4. Accumulate first and second moment estimates:

$${u}_{i} = {β}_{1} {u}_{i} + ( 1 - {β}_{1} ) {C}_{i}^{′} \\ {v}_{i} = {β}_{2} {v}_{i} + ( 1 - {β}_{2} ) {( {C}_{i}^{′} )}^{2}$$

Where β₁ and β₂ are some decay constants.
5. Calculate unbiased first and second moments estimates:

$${U}_{i} = {u}_{i} / ( 1 - {β}_{1}^{t} ) \\ {V}_{i} = {v}_{i} / ( 1 - {β}_{2}^{t} )$$

Where t is the current number of iterations.
6. Use the unbiased first and second moment estimates to update the value of pᵢ:

$${P}_{i} = {P}_{i} - {RU}_{i} / ( ε + \sqrt{{V}_{i}} )$$

Where ε is a small number to avoid division by zero.
7. Repeat steps 2 to 6 until training is done, e.g. the model parameters converge.

Although approaches using gradient moments like Adam above can converge fast, their convergences may generalize poorly, and their solutions may be worse than Stochastic Gradient Descent.

This invention is about a new Machine Learning method which automatically tunes the learning rates using inexpensive computations of the unmixed second-order derivative of the cost function relative to each parameter. Initially, an input learning rate R is set for all parameters, then in each iteration, each parameter may have a different adjusted learning rate. The adjusted learning rate R′ᵢ of parameter pᵢ is a function of the input learning rate and an estimate of the unmixed second-order derivative of the cost function relative to that parameter:

$${R}_{i}^{′} = f ( R , {C}_{i}^{″} )$$

Where f is a rate adjustment function, which may be referred to as adjustment function in the rest of this disclosure. C″ᵢ denotes an estimate of the unmixed second-order derivative of the cost function relative to parameter pᵢ. Unlike mixed second-order partial derivatives, the unmixed second-order derivative of a parameter is computed by keeping all other parameters constant. The adjustment function f is chosen such that when R is large, f(R, C″ᵢ) and C″ᵢ have a negative association, i.e. ∂f/∂(C″ᵢ) should be generally negative if f is differentiable with respect to C″ᵢ. In some embodiments, the input learning rate R can be a constant or infinite. In such cases, the adjustment function f is a function of one variable C″ᵢ. In other embodiments, the adjustment function may have additional variables such as weights to calculate an average estimate C″ᵢ which is a weighted average of multiple estimates of the unmixed second-order derivative of the cost function relative to the parameter.

Because the learning rate for each parameter is adjusted individually, the new method adjusts not only the learning rates but also the search direction in each iteration. This is different from approaches such as Backtracking Line Search which adjusts only the learning rate without changing the search direction. Unlike other second-order methods such as the Newton's method which involves computing the Hessian matrix of mixed and unmixed second-order partial derivatives, the new method does not calculate mixed second-order partial derivatives. Instead, only the unmixed second-order derivative relative to each parameter is needed.

Because the new method does not use mixed partial derivatives, it is dependent on the choice of parameters as the basis vectors for a coordinate system. Other second-order approaches which use the full Hessian matrix are independent of the choice of coordinate system. Although it is non-obvious and even counterintuitive to make the learning rates or step sizes dependent on the choice of coordinate system, it turns out that the new method is very effective in practice for a wide range of Machine Learning problems.

Here is an example embodiment of the new Machine Learning method using a rate adjustment function of unmixed second-order derivative estimates.
1. Initialize each model parameter pᵢ to some value Pᵢ.
2. Sample a batch of one or multiple input data points from the training data set, feed the input data points to the model to calculate output data points and their cost function C.
3. For each parameter pᵢ, make two small variations h and −h to its current value Pᵢ and recalculate the cost function C to get an estimate C′ᵢ of the first-order derivative of C and an estimate C″ᵢ of the unmixed second-order derivative of C relative to pᵢ:

$${C}_{i}^{′} = ( C ( {P}_{i} + h ) - C ( {P}_{i} - h ) ) / 2 h \\ {C}_{i}^{″} = ( C ( {P}_{i} + h ) - 2 C ( {P}_{i} ) + C ( {P}_{i} - h ) ) / {h}^{2}$$

4. Use the estimate C″ᵢ of the unmixed second-order derivative of C relative to pᵢ to calculate the adjusted learning rate for pᵢ:

$${R}_{i} = f ( R , {C}_{i}^{″} )$$

Where R is an input learning rate, and f is a rate adjustment function that takes the input learning rate and an estimate of the unmixed second-order derivative of the cost function as inputs and returns an adjusted learning rate.
5. Use the estimate C′ᵢ of the first-order derivative of C relative to pᵢ and the adjusted learning rate Rᵢ to update the value of parameter pᵢ.

$${P}_{i} = {P}_{i} - {R}_{i} \cdot {C}_{i}^{′}$$

6. Repeat steps 2 to 5 until training is done, e.g. the model parameters converge.

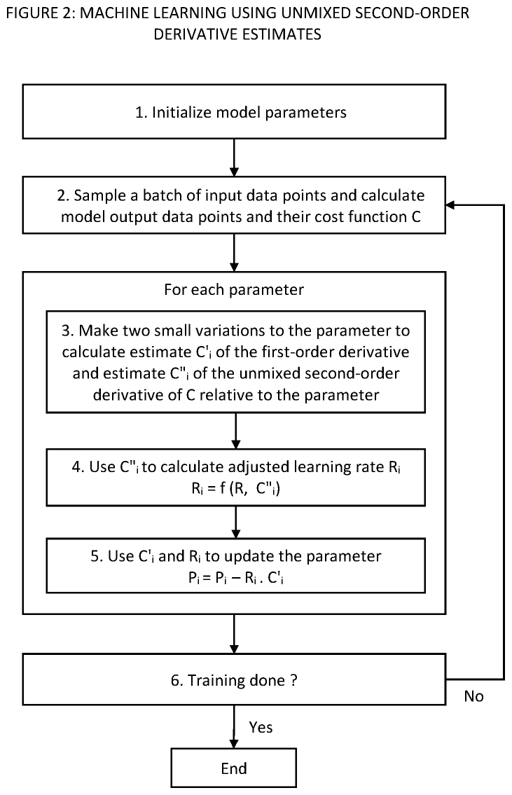

FIG. 2 shows a flow chart of the above embodiment of the new method. Different adjustment functions f can be used in the new method. In general, if C″ᵢ is zero or negative, or the input learning rate is small, the adjusted learning rate should be the same as the input learning rate. Otherwise, the adjustment function should be negatively correlated to the unmixed second-order derivative of the cost function, i.e. δf/δC″ᵢ≤0.

In one embodiment where C″ᵢ >0, the adjustment function is the minimum of the input learning rate and a fraction of the inverse of an estimate of the unmixed second-order derivative of the cost function:

$$f ( R , {C}_{i}^{″} ) = min ( R , α / {C}_{i}^{″} )$$

Where α is a number between 0 and 1. When R is large, of δf/δC″ᵢ=−α/C″ᵢ²<0.

In another embodiment, the adjustment function is:

$$f ( R , {C}_{i}^{″} ) = ( 2 α / π {C}_{i}^{″} ) arc tan ( R π {C}_{i}^{″} / 2 α )$$

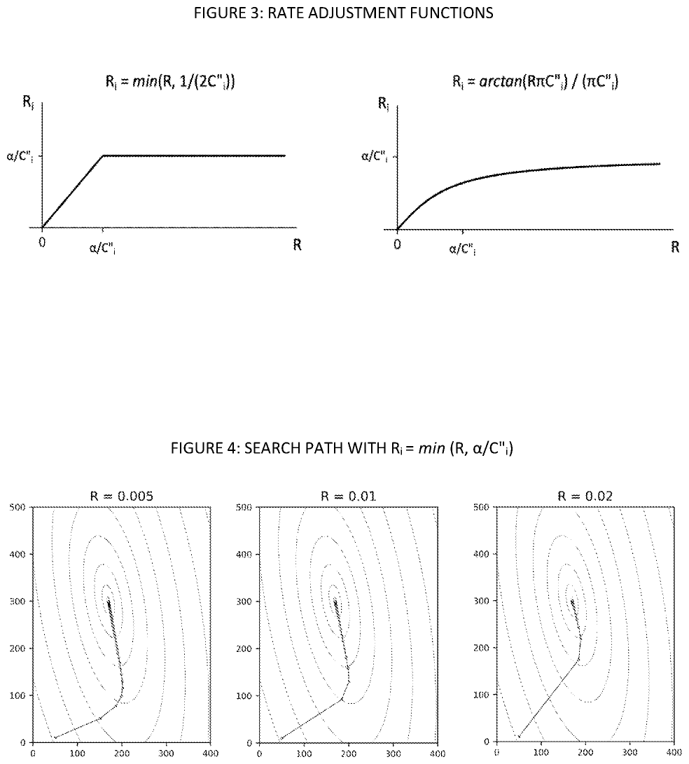

FIG. 3 plots the two adjustment functions above with α=0.5. Using such adjustment functions, the new method is very effective in preventing nonconvergence in Machine Learning. FIG. 4 shows the search paths of the new method using the adjustment function of min (R, α/C″ᵢ) at different input learning rates. At a small input learning rate of 0.005, the new method's search path is similar to that of the conventional Gradient Descent, which converges smoothly, albeit slowly, to the local minimum. At a higher rate of 0.01, the search path of the new method converges faster without overshoot. At a learning rate of 0.02 or higher, the new method quickly finds the local minimum without instability or nonconvergence.

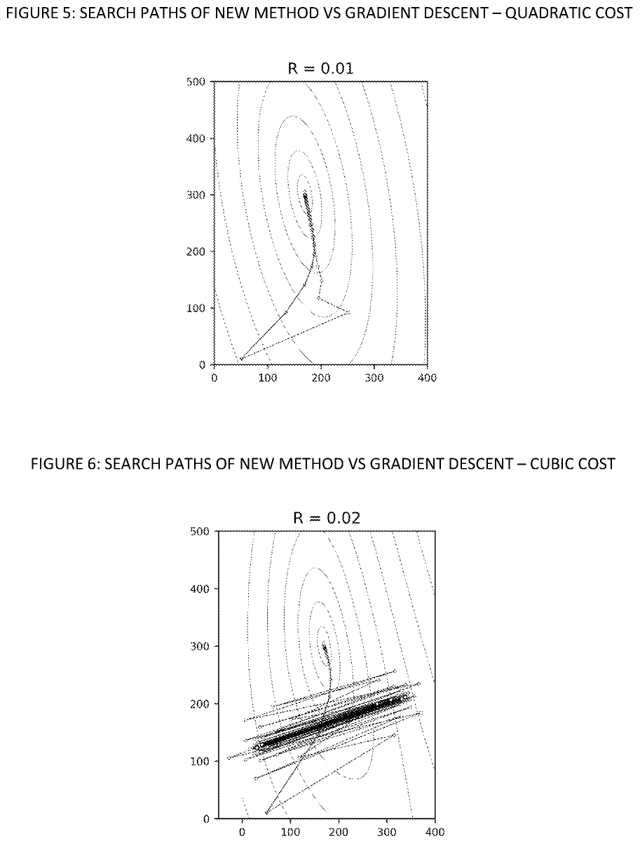

Note that in general, the search paths of the new method do not follow the same directions as the search paths of the conventional Gradient Descent. At higher learning rates, the new method has a more direct path toward the local minimum, resulting in faster convergences. FIG. 5 compares the search paths of the new method (solid lines) versus the conventional Gradient Descent method (dashed lines) with a learning rate of R=0.01.

The new method works well for Machine Learning problems with approximately quadratic cost functions as well as higher order cost functions. FIG. 6 compares the convergent path of the new method (solid lines) versus the nonconvergent path of the conventional Gradient Descent method (dashed lines) for a Machine Learning problem with a cubic cost function.

If a training data set contains noisy data, or random samplings are used, moving averages of multiple estimates of the first-order and/or unmixed second-order derivatives can be used to reduce noises and random fluctuations. For example, to update a parameter, instead of using a single estimate C′ᵢ of the first-order derivative in the current iteration, an embodiment may use a first derivative average Mᵢ which is an exponentially weighted sum of multiple values of C′ᵢ accumulated over current and past iterations.

$${M}_{i} = ( 1 - β ) {\sum }_{t = 1}^{n} {β}^{n - t} {C}_{i}^{′} ( t )$$

Where C′ᵢ (t) is the value of C′ᵢ at iteration t, and 0≤β<1. Alternatively. Mᵢ can be computed iteratively:

$${m}_{i} = β {m}_{i} + ( 1 - β ) {C}_{i}^{′}$$

$${M}_{i} = {m}_{i} / ( 1 - {β}^{t} )$$

The first derivative average Mᵢ then can be used instead of C′ᵢ to update the value of the parameter:

$${P}_{i} = {P}_{i} - {R}_{i} \cdot {M}_{i}$$

Similarly, to calculate the adjusted learning rates, an embodiment of the new method may use a second derivative average Nⱼ which is an exponentially weighted sum of multiple values of C″ᵢ accumulated over current and past iterations:

$${N}_{i} = ( 1 - γ ) {\sum }_{t = 1}^{n} {γ}^{n - t} {C}_{i}^{″} ( t )$$

Where C″ᵢ(t) is the value of C″ᵢ at iteration t, and 0≤γ<1. Alternatively, Nᵢ can be computed iteratively:

$${n}_{i} = γ {n}_{i} + ( 1 - γ ) {C}_{i}^{″}$$

$${N}_{i} = {m}_{i} / ( 1 - {γ}^{t} )$$

The second derivative average Nᵢ then can be used instead of C″ᵢ to calculate the adjusted learning rate:

$${R}_{i} = min ( R , α / {N}_{i} )$$

Here is an embodiment of the new method using average estimates of the first-order and unmixed second-order derivatives:
1. Initialize each model parameter pᵢ to some value Pᵢ and initialize m; and nᵢ to 0.
2. Sample a batch of one or multiple input data points from the training data set, feed the input data points to the model to calculate output data points and their cost function C.
3. For each parameter pᵢ, make two small variations h and −h to its current value P; and recalculate the cost function C to calculate an estimate C′ᵢ of the first-order derivative of C and an estimate C″ᵢ of the unmixed second-order derivative of C relative to pᵢ:

$${C}_{i}^{′} = ( C ( {P}_{i} + h ) - C ( {P}_{i} - h ) ) / 2 h$$

$${C}_{i}^{″} = ( C ( {P}_{i} + h ) - 2 C ( {P}_{i} ) + C ( {P}_{i} - h ) ) / {h}^{2}$$

4. Calculate first derivative average Mᵢ:

$${m}_{i} = β {m}_{i} + ( 1 - β ) {C}_{i}^{′}$$

$${M}_{i} = {m}_{i} / ( 1 - {β}^{t} )$$

Where t is the current number of iterations.
5. Calculate second derivative average Nᵢ:

$${N}_{i} = γ {n}_{i} + ( 1 - γ ) {C}_{i}^{″}$$

$${N}_{i} = {m}_{i} / ( 1 - {γ}^{t} )$$

6. Use the second derivative average Nᵢ to calculate adjusted learning rate Rᵢ:

$${R}_{i} = f ( R , {N}_{i} )$$

Where f is an adjustment function.
7. Use the first derivative average Mᵢ and the adjusted learning rate Rᵢ to update the value of parameter pᵢ:

$${P}_{i} = {P}_{i} - {R}_{i} \cdot {M}_{i}$$

8. Repeat steps 2 to 7 until training is done, e.g. the model parameters converge.

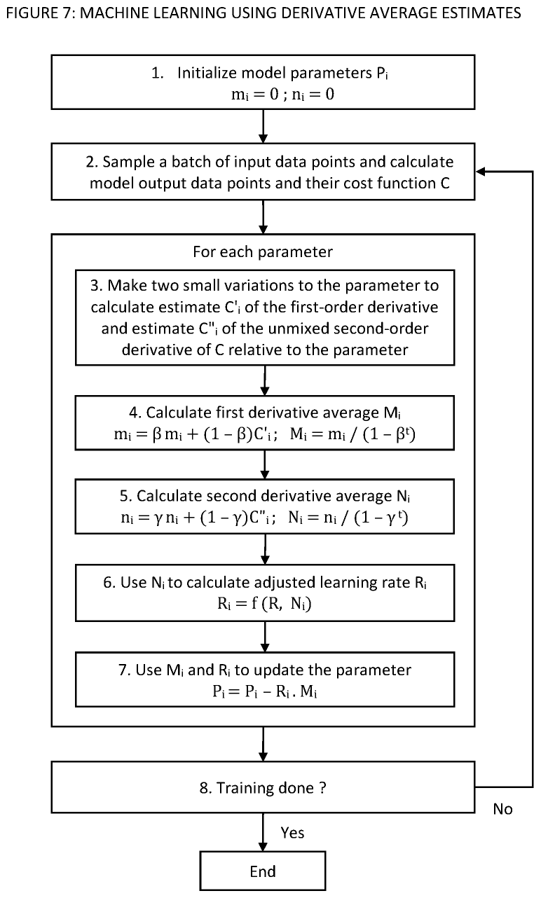

FIG. 7 shows a flow chart of the above embodiment of the new method using average estimates of the first-order and unmixed second-order derivatives. Note that the embodiment in FIG. 2 can be seen as a special case of the embodiment in FIG. 7 where β=0 and γ=0, i.e. the first and second derivative averages involve only an estimate from the current iteration rather than a weighted sum of multiple estimates over current and past iterations.

In addition to Machine Learning, the new method can also be used to solve other optimization problems. For example, here is an embodiment of the new method to search a multidimensional space for a point P that minimizes a cost function C.
1. Initialize each coordinate pᵢ of point P to some value Pᵢ.
2. Calculate the cost function C at point P.
3. For each coordinate pᵢ, make two small variations h and −h to its current value Pᵢ and recalculate the cost function C to get an estimate C′ᵢ of the first-order derivative of C and an estimate C″ᵢ of the unmixed second-order derivative of C relative to pᵢ:

$${C}_{i}^{′} = ( C ( {P}_{i} + h ) - C ( {P}_{i} - h ) ) / 2 h$$

$${C}_{i}^{″} = ( C ( {P}_{i} + h ) - 2 C ( {P}_{i} ) + C ( {P}_{i} - h ) ) / {h}^{2}$$

4. Use the estimate C″ᵢ of the unmixed second-order derivative of C relative to pᵢ to calculate adjusted step size Rᵢ:

$${R}_{i} = f ( R , {C}_{i}^{″} )$$

Where R is an initial step size, and f is an adjustment function that takes the initial step size and an estimate of the unmixed second-order derivative of the cost function C as inputs and returns an adjusted step size.
5. Use the estimate C′ᵢ of the first-order derivative of C relative to pᵢ and the adjusted step size Rᵢ to update the value of coordinate pᵢ.

$${P}_{i} = {P}_{i} - {R}_{i} \cdot {C}_{i}^{′}$$

6. Repeat steps 2 to 5 until point P converges to a minimum of the cost function C.

In some embodiments, in addition to R and C″ᵢ, the adjustment function f may take additional inputs, such as multiple values of C″ᵢ from previous iterations. Similarly, in step 5, a weighted average of multiple values of C′ᵢ can be used instead of the value of C′ᵢ in the current iteration to update the value of the coordinate.

In some embodiments, steps 4 and 5 may be combined for computational efficiency. For example, an embodiment may use the min adjustment function described above to update the value of pᵢ in one combined step:

$${P}_{i} = {P}_{i} - min ( R , α / {C}_{i}^{″} ) \cdot {C}_{i}^{t}$$

Or more generally:

$${P}_{i} = {P}_{i} - g ( R , {C}_{i}^{′} , {C}_{i}^{″} )$$

Where g is an update function which is a function of the input step size R, an estimate C′ᵢ of the first-order derivative of C, and an estimate C″ᵢ of the unmixed second-order derivative of C relative to pᵢ. The update function g may also take multiple estimates of C′ᵢ and C″ᵢ as inputs. In general, when C″ᵢ is positive, the update function g is positively correlated with C′ᵢ and negatively correlated with C″ᵢ.

What is claimed is:

1. A method of training a machine learning model with adaptive learning rates, comprising:
initializing parameters of the machine learning model;
using a cost function to measure how model outputs deviate from target outputs; and
updating the parameters iteratively, wherein in each iteration:
calculating the cost function using current values of the parameters; and
for each of the parameters, making at least two small variations to the current value of the parameter and recalculating the cost function to calculate an estimate of first-order derivative of the cost function relative to the parameter and an estimate of unmixed second-order derivative of the cost function relative to the parameter;
calculating a first derivative estimate of the parameter using one or multiple estimates of the first-order derivative of the cost function relative to the parameter;
calculating a second derivative estimate of the parameter using one or multiple estimates of the unmixed second-order derivative of the cost function relative to the parameter;
calculating an adjusted learning rate of the parameter using a rate adjustment function which is a function of an input learning rate and the second derivative estimate of the parameter; and
using the adjusted learning rate of the parameter and the first derivative estimate of the parameter to update the value of the parameter.

2. The method of claim 1, wherein the first derivative estimate of the parameter is an exponentially weighted average of a multitude of estimates of the first-order derivative of the cost function relative to the parameter in current and past iterations.

3. The method of claim 1, wherein the first derivative estimate of the parameter is the estimate of the first-order derivative of the cost function relative to the parameter in the current iteration.

4. The method of claim 1, wherein the second derivative estimate of the parameter is an exponentially weighted average of a multitude of estimates of the unmixed second-order derivative of the cost function relative to the parameter in current and past iterations.

5. The method of claim 1, wherein the second derivative estimate of the parameter is the estimate of the unmixed second-order derivative of the cost function relative to the parameter in the current iteration.

6. The method of claim 1, wherein the rate adjustment function is generally negatively correlated to the second derivative estimate of the parameter when the input learning rate is large.

7. The method of claim 1, wherein the rate adjustment function is a minimum of the input learning rate and a fraction of an inverse of the second derivative estimate of the parameter.

8. The method of claim 1, wherein the rate adjustment function is proportional to an arctangent of a multiplication of the input learning rate and the second derivative estimate of the parameter.

9. The method of claim 1, wherein the input learning rate is a constant and the rate adjustment function is a function of the second derivative estimate of the parameter.

10. The method of claim 1, wherein the two small variations to the current value of the parameter are a small number h and its negative-h, and the estimate of the unmixed second-order derivative of the cost function relative to the parameter is (C(Pᵢ+h)−2C (Pᵢ)+C (Pᵢ−h))/h², where C is the cost function and Pᵢ is the current value of the parameter.

11. An apparatus of training a machine learning model with adaptive learning rates, comprising a computer and a computer program that:
initializes parameters of the machine learning model;
uses a cost function to measure how model outputs deviate from target outputs; and
updates the parameters iteratively, wherein in each iteration the computer program:
calculates the cost function using current values of the parameters; and
for each of the parameters, makes at least two small variations to the current value of the parameter and recalculates the cost function to calculate an estimate of first-order derivative of the cost function relative to the parameter and an estimate of unmixed second-order derivative of the cost function relative to the parameter;
calculates a first derivative estimate of the parameter using one or multiple estimates of the first-order derivative of the cost function relative to the parameter;
calculates a second derivative estimate of the parameter using one or multiple estimates of the unmixed second-order derivative of the cost function relative to the parameter;
calculates an adjusted learning rate of the parameter using a rate adjustment function which is a function of an input learning rate and the second derivative estimate of the parameter; and
uses the adjusted learning rate of the parameter and the first derivative estimate of the parameter to update the value of the parameter.

12. The apparatus of claim 11, wherein the first derivative estimate of the parameter is an exponentially weighted average of a multitude of estimates of the first-order derivative of the cost function relative to the parameter in current and past iterations.

13. The apparatus of claim 11, wherein the first derivative estimate of the parameter is the estimate of the first-order derivative of the cost function relative to the parameter in the current iteration.

14. The apparatus of claim 11, wherein the second derivative estimate of the parameter is an exponentially weighted average of a multitude of estimates of the unmixed second-order derivative of the cost function relative to the parameter in current and past iterations.

15. The apparatus of claim 11, wherein the second derivative estimate of the parameter is the estimate of the unmixed second-order derivative of the cost function relative to the parameter in the current iteration.

16. The apparatus of claim 11, wherein the rate adjustment function is generally negatively correlated to the second derivative estimate of the parameter when the input learning rate is large.

17. The apparatus of claim 11, wherein the rate adjustment function is a minimum of the input learning rate and a fraction of an inverse of the second derivative estimate of the parameter.

18. The apparatus of claim 11, wherein the rate adjustment function is proportional to an arctangent of a multiplication of the input learning rate and the second derivative estimate of the parameter.

19. The apparatus of claim 11, wherein the input learning rate is a constant and the rate adjustment function is a function of the second derivative estimate of the parameter.

20. The apparatus of claim 11, wherein the two small variations to the current value of the parameter are a small number h and its negative −h, and the estimate of the unmixed second-order derivative of the cost function relative to the parameter is (C(Pᵢ+h)−2C(Pᵢ)+C (Pᵢ−h))/h², where C is the cost function and Pᵢ is the current value of the parameter.
